(19) United States
(12) Patent Application Publication
(10) Pub. No.: US 2016/0103453 A1
(43) Pub. Date: Apr. 14, 2016

(54) COMPUTERIZED SYSTEM FOR PRECISE DILUTION OF HIGH-SOLIDS LIQUIDS, SLURRIES AND POWDERS

(71) Applicant: David Bryan Hill, Lake Villa, IL (US)

(72) Inventor: David Bryan Hill, Lake Villa, IL (US)

(73) Assignee: RubiChem, LLC, Twinsburg, OH (US)

(21) Appl. No.: 14/879,665

(22) Filed: Oct. 9, 2015

Related U.S. Application Data
(60) Provisional application No. 62/061,754, filed on Oct. 9, 2014.

(51) Int. Cl. G05D 11/13; B05C 3/02; B05D 1/18

(52) U.S. Cl. CPC G05D 11/135; B05D 1/18; B05C 3/02

(57) ABSTRACT

An apparatus and method for precise dilution of a powder or liquid concentrate and maintenance of the resultant aqueous slurry apparatus is provided. The apparatus comprises at least one active solids level sensor, a controller, and control valves for providing additional water, slurry, or powder to the dilution. The method comprises determining with an active solids sensor a level of active solids in a dilution, transmitting the level of active solids to a controller, comparing with the controller the level of active solids with a predetermined active solids use level, and based on the active solids comparison, determining whether to deliver additional water or additional slurry or powder concentrate to the dilution.

### BACKGROUND

In the manufacture of finished rubber goods, rubber slabs (large sheets of rubber), strips (sheets of rubber divided into strips) and extrusions (rubber extruded and cut to length) are often intentionally stacked on pallets or placed in containers for interim storage and/or transportation before the next manufacturing step. The slabs, strips, and extrusions of rubber are generally treated with an anti-tack coating or “dip” (a high solids liquid, slurry, or powder concentrate diluted with water (to form a dilution)) to inhibit the tendency of the rubber to stick together while in storage. The dip coats the surfaces of the rubber and provides a physical barrier or partition that keeps the rubber in the individual slabs, strips or extrusions from coming into contact and sticking to other rubber slabs, strips, extrusions. Uncured rubber compounds that are in the form of pellets or granules also need to be treated with dip to prevent rubber-to-rubber sticking.

If the active solids of the dip are too low, the rubber slabs, strips, or extrusions will stick together during storage. This problem can be so serious that it is very difficult for workers to separate rubber slabs and strips that are stuck together. In such cases, the rubber is not processable and may even become waste product. If the active solids level of the aqueous coating is too high it may result in undesirable dusting problems in plant work areas. More significantly, the residual excessive dip that remains in finished rubber goods can be detrimental to ultimate rubber properties. For example, dip particles or other particles contained in the dip can serve as the nucleus for growth of cuts or tears in the finisher rubber article.

Rubber manufacturers are supplied with dip concentrates in aqueous (slurry) or powder (powder concentrate) form. The rubber manufacturer dilutes the dip concentrate with water to a predetermined active solids use level. For example, the manufacturer may dilute dip concentrates of 40 to 50 percent to levels of 0.05 to 12 percent. The active solids use level may be determined in a production lab to optimize the dip for the manufacturer's particular rubber compound. Furthermore, some manufacturers produce several different types of rubber compounds, potentially requiring the rubber manufacturer to change the dip's active solids level based on the compound's production requirements. Thus, there is a need for an apparatus/system and method that provides for the precise and rapid dilution of the dip concentrate to form a dilution.

Furthermore, current apparatuses and systems are used in a holding tank, not in a process tank. As a result, manufacturers lack the ability to accurately monitor and adjust the level of active solids in the dip dilution. For example, the holding tank remains at a constant temperature, but when the dip dilution is supplied to the process tank where it comes into contact with the rubber, the temperature of the dip dilution will rise causing some of the water in the dip dilution to evaporate resulting in higher solids. Likewise, density changes with heat. Thus, there is a need for an apparatus/system that can monitor and adjust the solids level in the process tank, independent of heat and density.

### BRIEF SUMMARY

In one aspect, an apparatus is provided, comprising at least one active solids level sensor, a controller, wherein the controller is configured to compare a level of active solids in a dilution based on data from the sensor with a predetermined active solids use level, and determine whether to deliver water to the dilution, to deliver a slurry or powder concentrate to the dilution, or to maintain the level of active solids based on the comparison, a water control valve for delivering water to the dilution, and a slurry control valve for delivering the slurry or powder concentrate to the dilution.

In another aspect, a method is provided, the method comprising determining with an active solids sensor a level of active solids in a dilution, transmitting the level of active solids to a controller, comparing with the controller the level of active solids with a predetermined active solids use level to generate an active solids comparison, based on the active solids comparison, determining whether to deliver water to the dilution, to deliver a slurry or powder concentrate to the dilution, or to maintain the level of active solids to generate an active solids determination, based on the active solids determination, instructing the water control valve to open, close or maintain a position, and based on the active solids determination, instructing the slurry control valve to open, close, or maintain a position.

### BRIEF DESCRIPTION OF THE FIGURES

FIG. 1 is a perspective view of an example apparatus in accordance with at least one embodiment;

FIG. 2 is another perspective view of example apparatus in accordance with at least one embodiment;

FIG. 3 is another perspective view of example apparatus in accordance with at least one embodiment;

FIG. 4 is a side view of an example apparatus in accordance with at least one embodiment;

FIG. 5 is a front view of an example apparatus in accordance with at least one embodiment;

FIG. 6 is a perspective view of an example apparatus in a tank in accordance with at least one embodiment;

FIG. 7 is a side view of an example apparatus in a tank in accordance with at least one embodiment;

FIG. 8 is a front view of an example apparatus in a tank in accordance with at least one embodiment;

FIG. 9 is a top view of an example apparatus in a tank in accordance with at least one embodiment; and

FIG. 10 is a simplified flow diagram of an example method that may be carried out to precisely dilution a powder or liquid dip concentrate and maintain the resultant aqueous slurry at the desired concentration level.

### DETAILED DESCRIPTION

Disclosed is an apparatus and method for precise dilution of a powder or liquid concentrate and maintenance of the resultant aqueous dilution (dip) concentration level used to coat the surface of rubber slabs, strips, or extrusions in order to reduce the tendency of the rubber slabs, strips or extrusions to stick together.

One embodiment of the apparatus comprises (1) a programmable logic controller (PLC) programmed with slurry solids dilution data and other commands; (2) a sensor that continuously monitors the active solids level of the dip in the tank (process vessel) and sends that reading to the PLC; (3) feed valves, such as solenoid valves, that control the addition of liquid slurry or powder concentrate and water to the tank; (4) pumps or augers (or an alternate delivery system, such as elevation) to feed the apparatus liquid slurry or powder concentrate; (5) solids level sensor(s) that continuously monitor the level of the diluted dip in the tank; and (6) level sensor(s) that maintain the dilution's operational level in the tank.

Each rubber compounder/manufacturer uses tanks that have unique heights and diameters. The dilution apparatus is portable and adjustable, and therefore designed to utilize the customer's existing tank(s) and to work with a range of different rubber products. This eliminates the need for a separate dilution system and allows manufacturers to be more efficient. The apparatus also allows the user to change the concentration level at any time during the process.

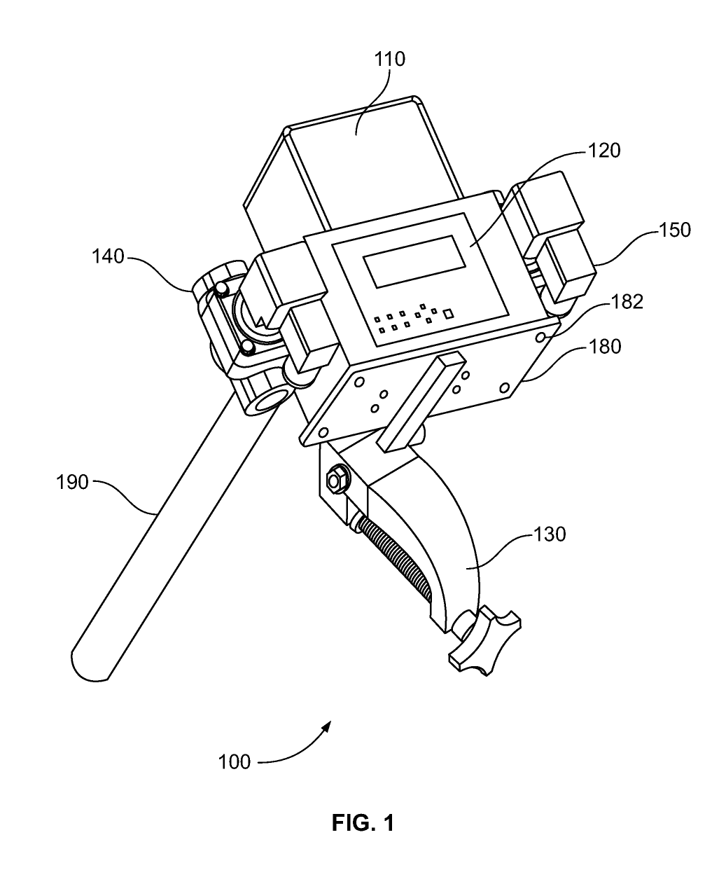

FIGS. 1, 2, and 3 show different perspective views of an example dilution apparatus 100. The dilution apparatus 100 may include a programmable logic controller (PLC) 110, a touch pad or other input device 120, an attachment clamp 130, a water control valve 140, and a slurry control valve 150 (making up a control and analyzer system 200). The touch pad 120 may be adjacent to the PLC 110. The water control valve 140 and the slurry control valve 150 may be located on opposite sides of the touch pad 120. The slurry control valve 150 allows for delivery of the liquid slurry or powder concentrate to the dip dilution. The attachment clamp 130 allows the apparatus 100 to attach to various points in a tank. In alternative embodiments, at least one level sensor 160 and the active solids sensor 170 may be in the tank and a bracket may be used to attach the PLC 110 and/or touch pad 120 to a nearby location or on existing process equipment. The dilution apparatus 100 may further include at least one level sensor 160 and an active solids sensor 170. The level sensor 160 and the active solids sensor 170 may be commercially available sensors. The active solids sensor 170 may be positioned below the level sensor 160. The sensor(s) may be located in the tank and other parts, such as solenoids, may be located elsewhere, such as on a wall. In an alternative embodiment, the sensor may send a wireless signal to a station.

The apparatus's PLC 110 may be attached to the sidewall of the tank or mounted in another location. In an exemplary embodiment, the PLC 110 may be attached to a tank insert 180. The tank insert 180 may clamp onto the wall of the tank and may be adjustable in height. In some embodiments, the tank insert 180 may be about five (5) inches wide. The tank insert 180 may include a plurality of pre-drilled holes 182, which may be used to mount additional level sensors. The number and spacing of additional level sensors will depend on the size and shape of the customer's tank. In some embodiments, the pre-drilled holes 182 may be vertically aligned and may be spaced about three (3) inches apart. Wire(s) from the active solids sensor 170 and the level sensor(s) 160 may be secured on the tank insert 180 with cable ties.

The level sensor(s) 160 may be located at a location within the tank such that there is enough headroom in the tank to allow for adjustment of the solids. The level sensor(s) 160 may also be movable, such that it can be adjusted to allow for different levels of liquid within the tank. Several different liquid level controls can be employed by the apparatus, including but not limited to, floats, radar, ultrasonic, and optic sensors. The level sensor(s) 160 may be a low-level sensor, such that when the liquid level (undiluted) in the tank reaches the pre-determined low level a low-level signal is sent by the level sensor(s) 160 to the PLC 110. This low-level signal may trigger the start of a batch process, wherein the PLC 110 will add a combination of concentrate and water to bring the diluted dip in the tank to the pre-determined operational use level. The operational use level is set to level that will allow enough room in the tank to accommodate a change in the amount of active solids in the dilution. The batch size may be determined by user input and/or tank size.

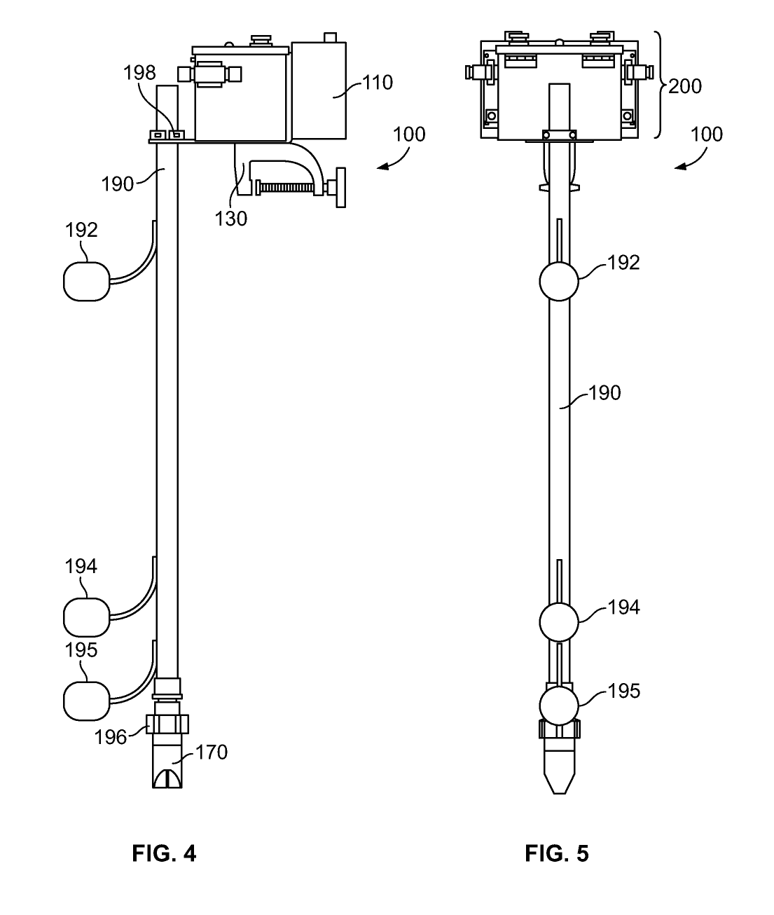

The apparatus 100 accurately dilutes the supplied concentrate to the customer's desired active solids use level based on the real-time active solids level obtained by the active solids sensor 170. The active solids sensor 170 may be positioned in the bottom of the tank. In some embodiments, the active solids sensor 170 may be positioned about three (3) inches from the bottom of the tank. In yet other embodiments, the apparatus may comprise more than one active solids sensor. The active solids sensor 170 may be attached to a pole 190, which may be attached to the tank insert 180. The actives solids sensor 170 can be adjusted as needed to accommodate readings, for example, with a collar 196 and two sets of screws to tighten and loosen. In other embodiments, additional sensors may be mounted using a first collar 196 on the tank insert 180. The pole 190 may have a telescoping function, such that it can adjust to the depth of the tank. In other embodiments, the pole 190 may be adjusted to the depth of the tank with a second collar 198 and screws by moving the pole 190 in relation to the control and analyzer system 200 (see FIGS. 4 and 5).

There are several types of sensor technologies that can be employed by the apparatus, including but not limited to, total dissolved solids, ultrasonic attenuation, pH, turbidity, and conductivity. Active solids data acquired through laboratory study using the selected sensor technology can be loaded into the system's PLC 110. For example, dilution solids curves for each desired product may be stored in the PLC's memory and identified by a code. The user may enter the code for the desired product on the PLC 110 and the active solids sensor 170 may send a signal to the PLC 110. The PLC 110 compares the active solids data with the real-time sensor readings to determine what action, if any, to take to maintain the programmed active solids level in the tank. If the active solids level is too low, concentrate may be added through the slurry control valve 150. If the active solids level is too high, water may be added through the water control valve 140. The active solids data may be displayed on the PLC's screen. If desired, the real-time signal from the apparatus' active solids sensor 170 may be sent to another computing device, such as a computer or a smart phone. For example, the signal from the active solids sensor 170 may also be tied into the user's quality system. In some embodiments, the actual solids level determined by the active solids sensor 170 is compared with the desired solids level on at predetermined intervals.

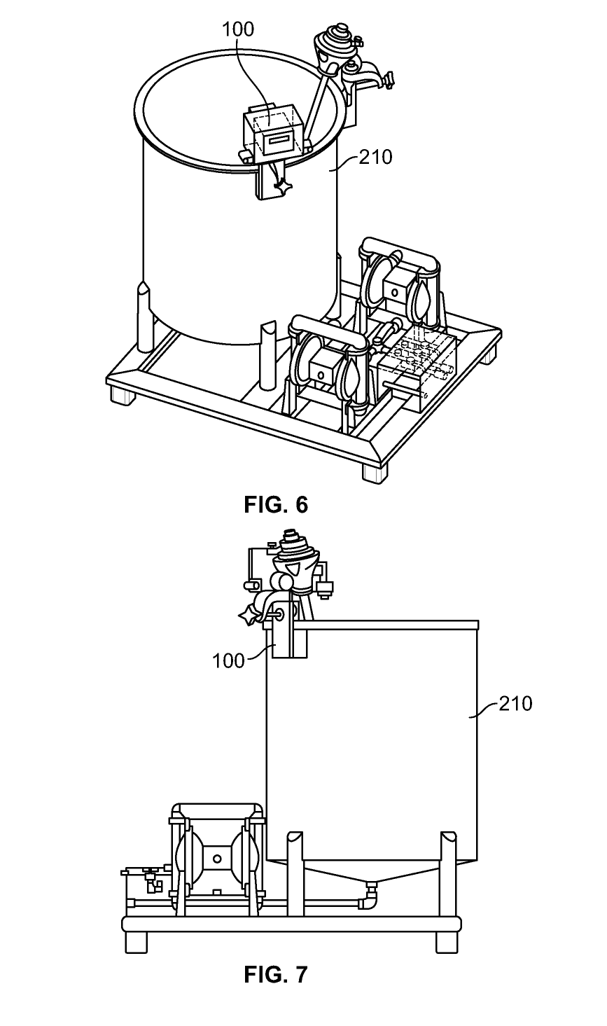

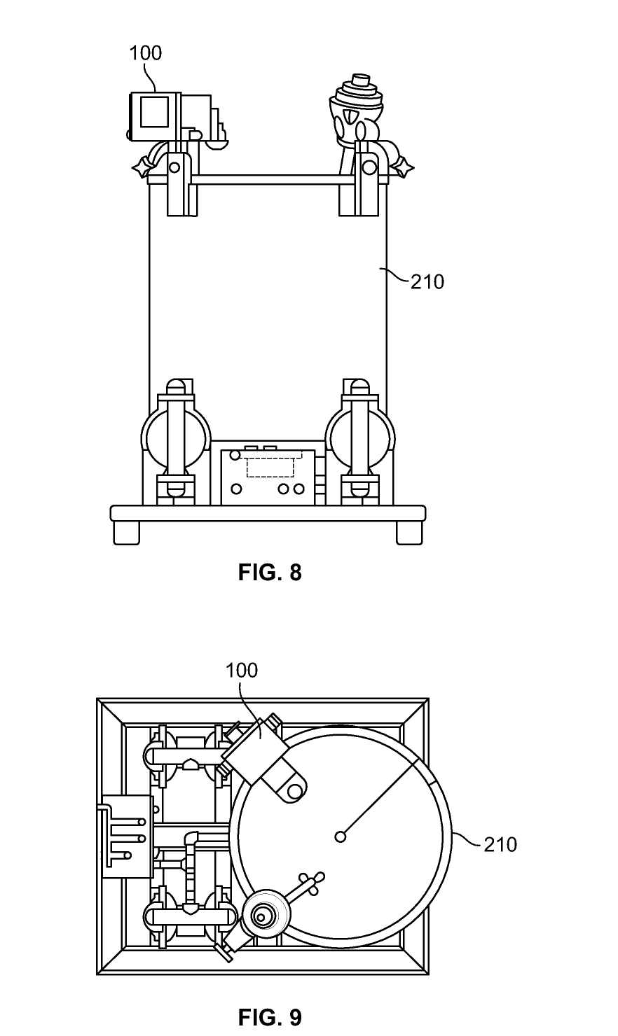

During use, the active solids of the diluted dip will change due to production factors, such as evaporation and solids pick-up (as the substrate goes through the dip, it takes the solid out, but the water runs back down into the process tank). The apparatus in the present disclosure monitors the process tank, rather than make-up tank as in previous apparatuses. FIGS. 6-9 show the dilution apparatus 100 attached to a process tank 210. The apparatus 100 continuously monitors the real-time active solids level of the diluted dip and adds water or slurry concentrate to keep the dip dilution within the rubber compounder's per-determined active solids level. The apparatus also allows the customer to enter a command on the system's PLC that will change the active solids level of the diluted dip. The apparatus 100 will add slurry or powder concentrate and/or water until the newly programmed active solids level is reached. The apparatus 100 will then maintain that active solids level dilution in the tank.

The apparatus 100 may also include additional level controls. These level controls may be attached to the pipe 190, as shown in FIGS. 3-5. For example, the apparatus 100 may include an operational level control 192 to ensure that there is enough headroom in the tank to accommodate a change in solids level and/or a high-level alarm to deactivate the apparatus 100 if the level in the tank reaches a predetermined height. If the high-level alarm is activated, the operator may 1) clear the alarm; 2) clear the alarm and manually add product; or 3) clear the alarm and manually add water. The apparatus may also include a low level control 194. The low level control 194 may include a low-level alarm to alert the user if the level drops below a predetermined height. The apparatus may also include a second low level control 195, located below low level control 194, in order to ensure that active solids sensor is always in contact with the dilution.

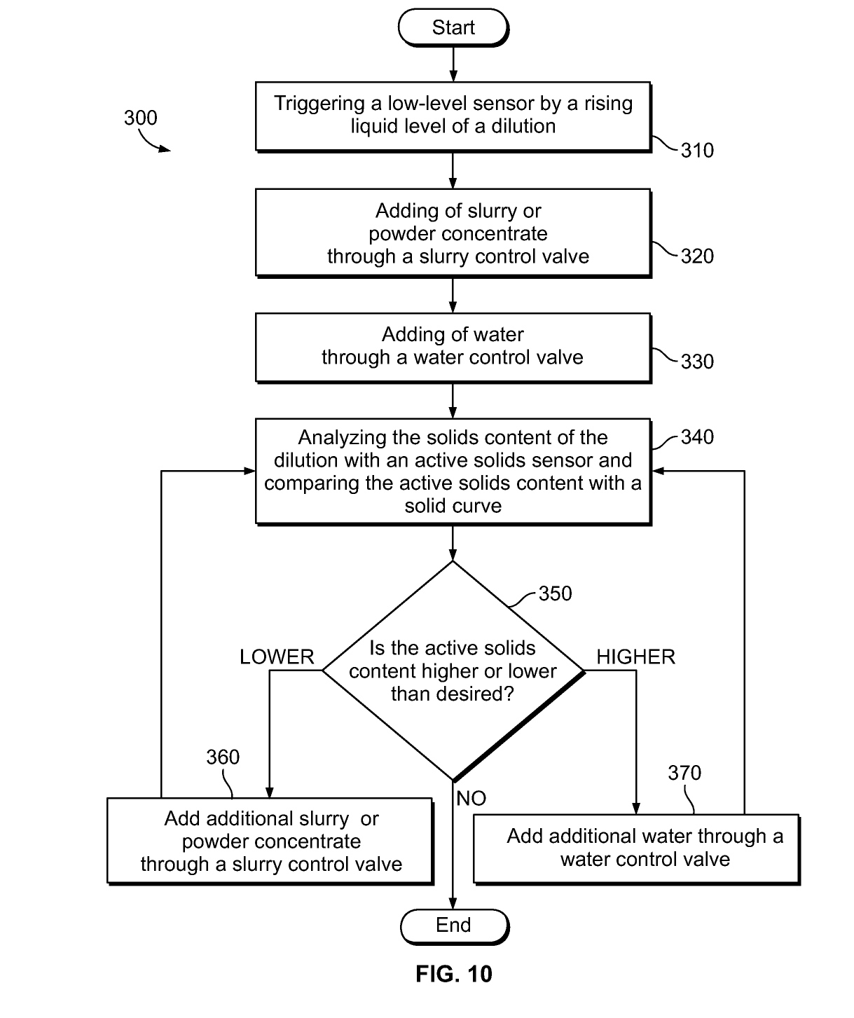

FIG. 10 depicts a simplified flow diagram of an example method 300 that may be carried out to precisely dilute a powder or liquid dip concentrate and maintain the resultant aqueous slurry at the desired concentration level. Method 300 shown in FIG. 10 presents an embodiment of a method that, for example, could be used with the apparatus 100.

In addition, for the method 300 and other processes and methods disclosed herein, the flowchart shows functionality and operation of one possible implementation of the present embodiments. In this regard, each block may represent a module, a segment, or a portion of a program code, which includes one or more instructions executable by a processor for implementing specific logical functions or steps in the process. For example, such instructions may be executable by the PLC 110.

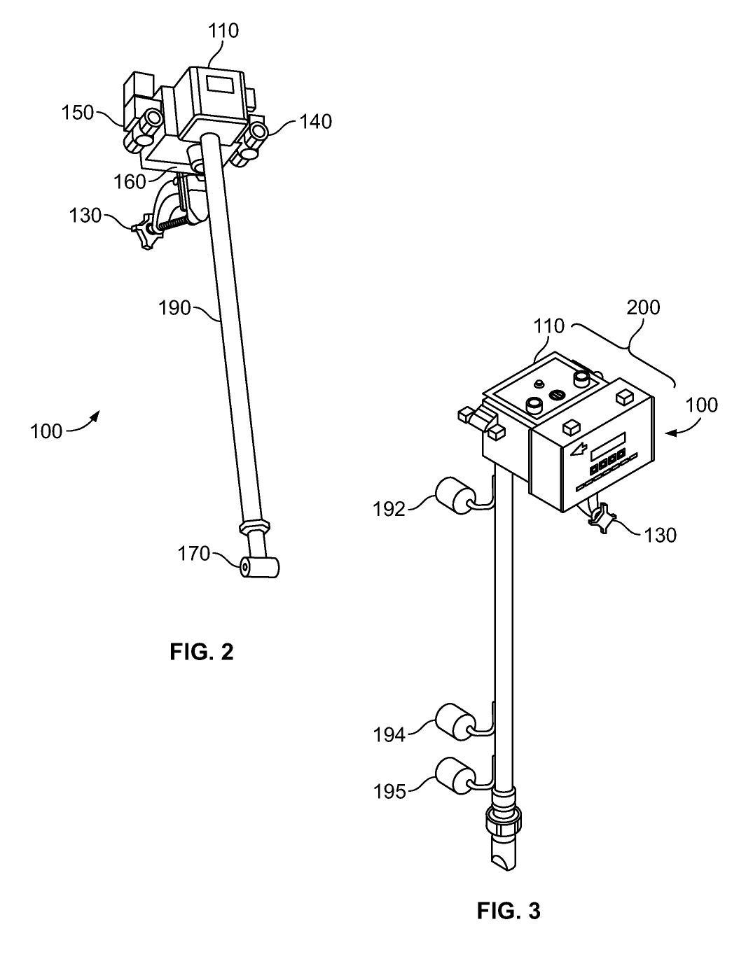

Initially, the method 300 includes triggering a low-level sensor by a rising liquid level of a dilution, at block 310. The low-level sensor may be the level sensor 160 of FIGS. 1 and 2.

Once the low-level sensor is triggered, the method 300 then includes adding slurry or powder concentrate through a control valve, such as slurry control valve 150, at block 320. The method 300 then includes adding water through a water control valve, such as water control valve 140, at block 330. The steps at blocks 320 and 330 may occur independently or simultaneously.

Next, the method 300 includes analyzing the solids content of the dilution with an active solids sensor, such as active solids sensor 170, and comparing the active solids content with a solid curve, at block 340. The method 300 then includes analyzing the active solids content to determine if it is higher or lower than desired, at block 350. If the active solids content is lower than desired, the method 300 then includes adding additional slurry or powder concentrate, at block 360. If the active solids content is higher than desired, the method 300 then includes adding additional water, at block 370. The steps at blocks 340, 350, 360, and 370 are repeated until the active solids content is within the desired range.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims, along with the full scope of equivalents to which such claims are entitled. It is also to be understood that the terminology used herein is for the purpose of describing particular embodiments only, and is not intended to be limiting.

What is claimed is:

1. An apparatus comprising:
at least one active solids level sensor;
a controller, wherein the controller is configured to compare a level of active solids in a dilution based on data from the sensor with a predetermined active solids use level; and
determine whether to deliver water to the dilution, to deliver a slurry or powder concentrate to the dilution, or to maintain the level of the dilution's active solids, based on the comparison;
a water control valve for delivering water to the dilution; and
a slurry control valve for delivering the slurry or powder concentrate to the dilution.

2. The apparatus of claim 1, further comprising a plurality of liquid level control float sensors.

3. The apparatus of claim 2, wherein at least one of the liquid level control float sensors is an overflow float sensor.

4. The apparatus of claim 2, wherein at least one of the liquid level control float sensors is a system control float sensor.

5. The apparatus of claim 2, wherein at least one of the liquid level control float sensors is a low level float sensor.

6. The apparatus of claim 1, wherein the apparatus is connected to a tank.

7. The apparatus of claim 1, wherein the dilution is a coating.

8. The apparatus of claim 1, wherein the predetermined active solids use level is a value on a dilution solids curve.

9. The apparatus of claim 1, wherein the controller is a programmable logic controller (PLC).

10. The apparatus of claim 1, wherein the controller comprises a touch pad or other input device.

11. The apparatus of claim 1, wherein the controller is connected to a nearby location or to existing process equipment.

12. The apparatus of claim 1, further comprising:
a tank insert bracket fastened to a wall of a tank or on a nearby location;
a pole that is fastened to the tank insert bracket, wherein the at least one active solids level sensor is mounted to a lower end of the pole.

13. The apparatus of claim 12, wherein the length of the pole is adjustable.

14. A method, comprising:
determining with an active solids sensor a level of active solids in a dilution;
transmitting the level of active solids to a controller;
comparing with the controller the level of active solids with a predetermined active solids use level to generate an active solids comparison;
based on the active solids comparison, determining whether to deliver water to the dilution, to deliver a slurry or powder concentrate to the dilution, or to maintain the level of active solids to generate an active solids determination;
based on the active solids determination, instructing the water control valve to open, close or maintain a position; and
based on the active solids determination, instructing the slurry control valve to open, close, or maintain a position.

15. The method of claim 14, further comprising monitoring, by a plurality of sensors, a liquid level.

16. The method of claim 15, further comprising, based on the liquid level and comparison, determining an amount of water to deliver to the dilution, an amount of the slurry or powder concentrate to deliver to the dilution, or to maintain the liquid level.

17. The method of claim 14, wherein the dilution is a coating.

18. The method of claim 14, wherein the predetermined active solids use level is a value on a dilution solids curve.

19. The method of claim 14, wherein the controller is a programmable logic controller (PLC).

20. The method of claim 14, further comprising transmitting the level of active solids to a computing device.
